(19) United States
(12) Patent Application Publication
(10) Pub. No.: US 2002/0094146 A1
(43) Pub. Date: Jul. 18, 2002

(54) Planar packaged optical module and transmission substrate using planar package optical module

(76) Inventor: Takahiro Yamaguchi, Tokyo (JP)

Correspondence Address: Steven M. Rabin, RABIN & BERDO, P.C., Suite 500, 1101 14th Street, N.W., Washington, DC, 20005, US

(21) Appl. No.: 10/082,307

(22) Filed: Feb. 26, 2002

Related U.S. Application Data
(63) Continuation-in-part of application No. 09/697,294, filed on Oct. 27, 2000.

(30) Foreign Application Priority Data
Apr. 25, 2000 (JP) 2000-123853

(51) Int. Cl. G02F 1/035

(52) U.S. Cl. 385/2

(57) ABSTRACT

A planar packaged optical module in which shifting of an optical fiber and a ferrule from their design positions and positional displacement of an optical fiber within a ferrule resulting from a movement of the optical fiber therein can be prevented, and which is suitable for reflow soldering. The planar packaged optical module of the present invention is provided with a housing formed of epoxy resin or the like with a lid, an Si substrate provided within the housing, a semiconductor laser device provided on the Si substrate, a ferrule which is adhered to a notch portion provided on the housing and which retains an optical fiber therein, and an optical fiber which is adhered to the Si substrate in a state in which the optical fiber is passed from the outside to the inside of the housing through the ferrule and disposed therein such that one end surface of the optical fiber opposes an active layer of the semiconductor laser device. The ferrule and the optical fiber are adhered to one another by an adhesive that has a glass-transition temperature Tg higher than the glass-transition temperature of the adhesive, which adheres the housing and the ferrule to one another.

### CROSS REFERENCE TO RELATED APPLICATIONS

This application is a continuation in part application of Ser. No. 09/697,294, filed Oct. 27, 2000, the subject matter of which is incorporated herein by reference.

### BACKGROUND OF THE INVENTION

The present invention relates to a planar packaged optical module, and a transmission substrate using the planar packaged optical module, and in particular a planar packaged optical module that reciprocally or unilaterally converts electrical signals and optical signals, and a transmission substrate using the planar packaged optical module.

A planar packaged optical module is an electronic part that reciprocally or unilaterally converts electrical signals and optical signals, and is principally used in key equipment for optical communications.

Such a planar packaged optical module generally has a structure like the one illustrated in FIGS. 4 and 5A.

That is, a planar packaged optical module generally has a housing 50 formed of epoxy resin or the like with a lid (the lid is indicated in FIG. 5A), an Si substrate 52 provided within the housing 50, a semiconductor laser device 54 (hereinafter referred to as an LD) provided on the Si substrate 52, a ferrule 56 which is adhered by an adhesive to the housing in a state in which the ferrule 56 is passed through the housing 50, and an optical fiber 58 which is adhesively retained within the ferrule 56 and is adhered to the Si substrate 52 in a state in which the optical fiber 58 is disposed so that one end surface of the optical fiber 58 opposes an active layer of the LD 54.

The Si substrate 52 is provided with an optical fiber mounting portion 52a and an LD mounting portion 52b that are separated by a separation groove 52c. A V-groove for mounting the optical fiber is formed on the optical fiber mounting portion 52a along a direction perpendicular to the separation groove 52c. The LD 54 which converts electrical signals input from the outside into optical signals is fixedly provided on the LD mounting portion 52b.

The optical fiber 58 is disposed at a position such that one end surface of the optical fiber 58 precisely opposes the active layer of the LD. The optical fiber 58 is retained within the ferrule 56 at a notch portion of the housing 50. Within the housing 50, in a state in which a glass plate 60 which prevents the optical fiber 58 from rising up out of the V-groove is provided at the upper side of the optical fiber 58, the contact surface of the optical fiber 58 is adhesively fixed in the V-groove (not illustrated), which is provided on the optical fiber mounting portion 52a, by an adhesive 67 of UV setting or the like. The end surface of the optical fiber 58 which opposes the active layer of the LD 58 is stress-ruptured to a mirror-finished surface, while the other end surface of the optical fiber 58 is polished to a convex spherical surface.

The ferrule 56 which retains the optical fiber 58 at a notch portion of the housing 50 is structured to be substantially cylindrical. The ferrule 56 adhesively retains at the inner peripheral surface thereof the optical fiber 58 with an adhesive, while the outer peripheral surface of the ferrule 56 is fixed to the housing 50 with an adhesive. The adhesive which fixes the ferrule 56 to the housing 50 and the adhesive which fixes the optical fiber 58 to the inside of the ferrule 56 are epoxy resin adhesives which have a glass-transition temperature Tg of about 125° C.

In the planar packaged optical module 70 of the structure described above, lead portions 72 are placed on electrodes 82 of a distribution substrate 80 with solder balls 84 interposed between the lead portions 72 and the electrodes 82 as illustrated in FIG. 6A. Reflow soldering is performed. Thereafter, the electrodes 82 of the distribution substrate 80 and the lead portions 72 are electrically bonded by leaving them for about thirty seconds in a high-temperature environment at 240° C. as illustrated in FIG. 6B.

In the planar packaged optical module of the structure described above, the housing and the ferrule, and the ferrule and the optical fiber are respectively adhered to one another with an adhesive made of a resin, and the glass-transition temperature Tg of these adhesives is of a range of from about 100° C. to about 125° C.

When the electrodes of the distribution substrate are bonded with the lead portions by solder balls or the like in a high-temperature environment at 240° C. for a bonding time of thirty seconds, the adhesive which bonds the housing and the ferrule and the adhesive which binds the housing and the ferrule and the adhesive which binds the ferrule and the optical fiber undergo glass-transition and harden once they have softened at almost the same time.

Because the adhesive which binds the housing and the ferrule and the adhesive which binds the ferrule and the optical fiber are fixed once they have softened at virtually the same time, sometimes the optical fiber slips out of position in the direction in which it is drawn into the housing at a time the adhesives have softened as illustrated in FIG. 5B.

When the planar packaged optical module of the structure described above is bonded onto a distribution substrate by reflow soldering, the adhesive which binds the optical fiber and the Si substrate has softened. Thereby, a distance between the optical fiber and the LD is sometimes displaced.

When such positional displacement occurs, the output variance from the optical fiber ends up exceeding idB and noise increases. Therefore, there has been the drawback in that bonding a conventional planar packaged optical module onto the distribution substrate by reflow soldering which uses solder balls or the like is difficult.

### SUMMARY OF THE INVENTION

In order to overcome such drawbacks, an object of the present invention is to provide a planar packaged optical module in which shifting of an optical fiber and a ferrule from their design positions and positional displacement of the optical fiber within the ferrule resulting from a movement of the optical fiber therein can be prevented, and which is suitable for reflow soldering. Another object of the present invention is to provide a transmission substrate to mount the planar packaged optical module on a distribution substrate. The planar packaged optical module can prevent from changing a distance between the optical fiber and an LD at a time of reflow soldering.

In order to achieve this object, according to the present invention, a planar packaged optical module includes: a housing; a mounting portion provided within the housing;

a conversion device provided within the housing, the conversion device being operable for converting one of an electric signal and an optical signal substantially into the other; a retaining member provided in the housing; an optical fiber the optical fiber being mounted on the mounting portion such that an end surface of the optical fiber opposes the conversion device, being fixed to the retaining member, and extending from the inside to the outside of the housing; in which the retaining member is adhered to the housing by a first adhesive, the first adhesive being made of a first resin having an intrinsic glass-transition temperature, and the retaining member is adhered to the optical fiber by a second adhesive, the second adhesive being made of a second resin having an intrinsic glass-transition temperature greater than the glass-transition temperature of the first resin.

In the invention, the glass-transition temperature of the second adhesive, which adheres the retaining member and the optical fiber to one another, is higher than the glass-transition temperature of the first adhesive, which adheres the housing and the retaining member to one another.

Therefore, when reflow is performed, the second adhesive which adheres the retaining member and the optical fiber to one another hardens after the first adhesive which adheres the housing and the retaining member to one another hardens. Timing so that the adhesives which adhere between the housing and the retaining member, and between the retaining member and the optical fiber harden is displaced.

Accordingly, since displacement of the optical fiber due to movements of the optical fiber within the retaining member in an environment having a temperature higher than the glass-transition temperature of the adhesives at the time of reflow soldering and the like can be prevented, output variance from the optical fiber can be suppressed.

It is preferable that the adhesives are thermoplastic resins. It is further preferable that the thermoplastic resins are epoxy resin adhesives.

According to the present invention, a transmission substrate for mounting a planar packaged optical module on a distribution substrate by using soldering, in which the planar packaged optical module includes: a housing; a mounting portion provided within the housing; a conversion device provided within the housing, the conversion device being operable for converting one of an electric signal and an optical signal substantially into the other; a retaining member provided in the housing; an optical fiber being mounted on the mounting portion such that an end surface of the optical fiber opposes the conversion device, being fixed to the retaining member, and extending from the inside to the outside of the housing, and in which the optical fiber is adhered to the mounting portion by an adhesive, the adhesive being made of a resin having an intrinsic glass-transition temperature greater than a melting point of soldering.

In the invention, an Si substrate and the optical fiber are adhered by an adhesive having a glass-transition temperature higher than the melting point of soldering. Therefore, the adhesive which adheres the optical fiber and the Si substrate is never softened at a time of reflow soldering. It is possible to prevent from changing a distance between the optical fiber and an LD, and thereby output variance from the optical fiber can be suppressed.

It is preferable that the adhesive is a polyimide resin or a glass of a low melting point.

It is further desirable that the retaining member extends from the inside to the outside of the housing.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a partial perspective view which illustrates a structure of a planar packaged receptacle optical module of an embodiment of the present invention.

FIG. 2 is a perspective view which illustrates a structure of an Si substrate illustrated in FIG. 1.

FIG. 3A is a sectional view cut along the line A-A of FIG. 1.

FIG. 3B is an expanded view cut along the line B-B of FIG. 3A.

FIG. 4 is a partial perspective view illustrating a structure of a conventional planar packaged receptacle optical module.

FIG. 5A is a sectional view cut along the line C-C of FIG. 4.

FIG. 5B is an expanded view cut along the D-D of FIG. 5A.

FIG. 6A is an explanatory view illustrating a state prior to packaging, of explanatory views illustrating a packaging method of a conventional planar packaged receptacle optical module and a manufacturing method of a transmission substrate of a second embodiment.

FIG. 6B is an explanatory view illustrating a state after packaging.

### DETAILED DESCRIPTION OF THE INVENTION

The invention will now be described based on preferred embodiments, which do not intend to limit the scope of the present invention, but rather to exemplify the invention. All of the features and the combinations thereof described in the embodiments are not necessarily essential to the invention.

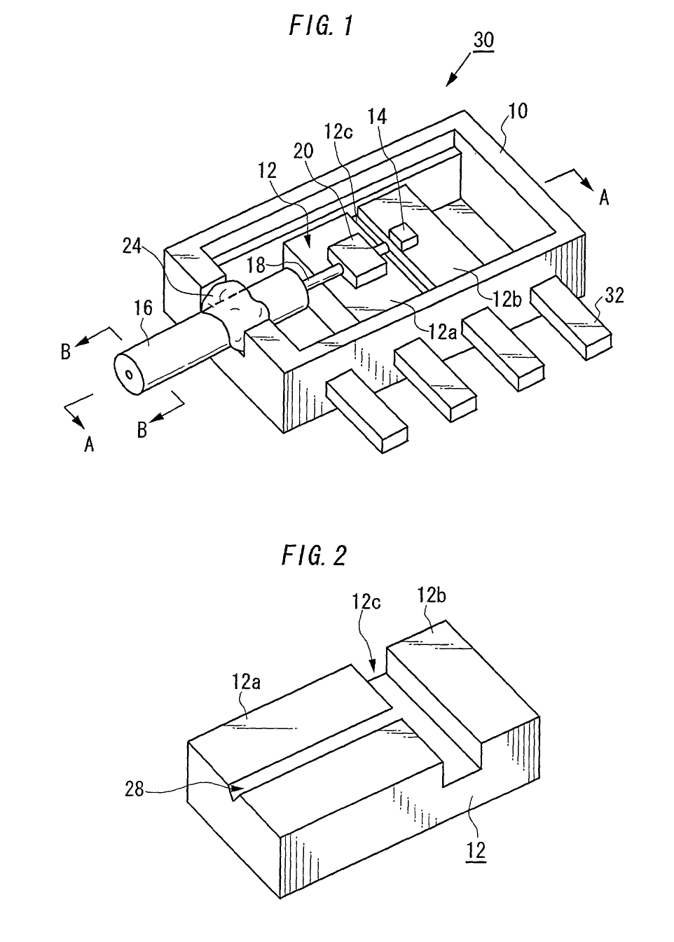

An embodiment of the present invention will hereinafter be described with reference to FIGS. 1 to 2, 3A, and 3B. As illustrated in FIG. 1, a planar packaged receptacle optical module of the present embodiment is provided with a housing 10 formed of epoxy resin or the like with a lid (not illustrated in FIG. 1), an Si substrate 12 provided within the housing 10, a semiconductor laser device 14 (hereinafter referred to as an LD) provided on the Si substrate 12, a ferrule 16 which is adhered to a notch portion provided on the housing 10 and which retains an optical fiber 18 therein, and an optical fiber 18 which is adhered to the Si substrate 12 in a state in which the optical fiber 18 is disposed so that it is inserted from the outside to the inside of the housing by being passed through the ferrule 16, and one end surface of the optical fiber 18 opposes an active layer of the LD 14. Lead portions 32 penetrate the housing 10. The lead portions 32 are electrically connected to the LD14 such that electric signals are supplied from the outside of the housing 10 to the LD 14 and, on the other hand, electric signals generated from the LD14 are transmitted to the outside of the housing 10. The ferrule 16 corresponds to a retaining member, and the Si substrate 12 corresponds to a mounting portion in the present invention.

As illustrated in FIG. 2, an upper later of the Si substrate 12 is divided by a separation groove 12c into an optical fiber mounting portion 12a and an LD mounting portion 12b. A V-groove 28 which extends in a direction perpendicular to the separation groove 12c is formed on the optical fiber mounting portion 12a in a central portion thereof. The optical fiber is mounted in the V-groove 28. An LD 14 which converts electrical signals input from the outside into optical signals is fixedly positioned on the LD mounting portion 12b so that the active layer of the LD is aligned with a high degree of precision at a position determined in advance with respect to the V-groove 28. The alignment is conducted by using an infrared-transmitting dice bonder or the like at a submicron unit.

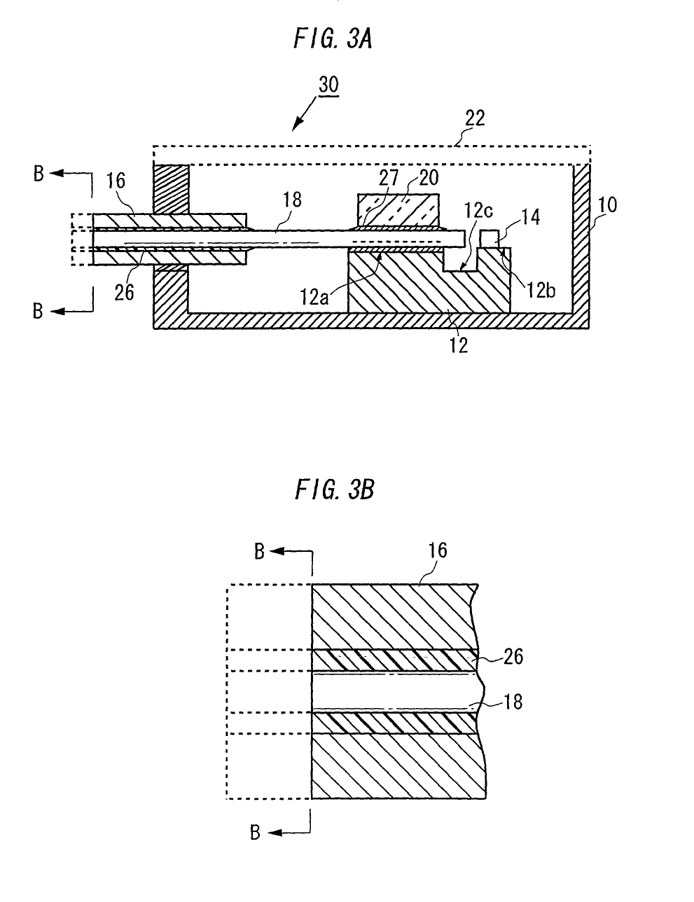

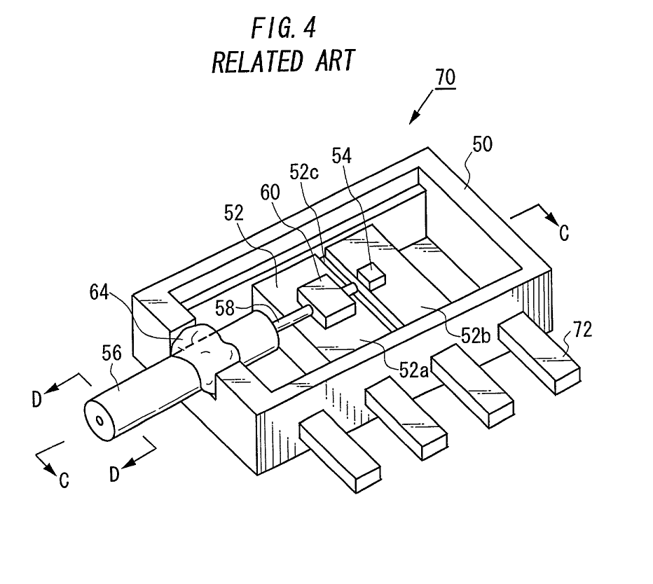

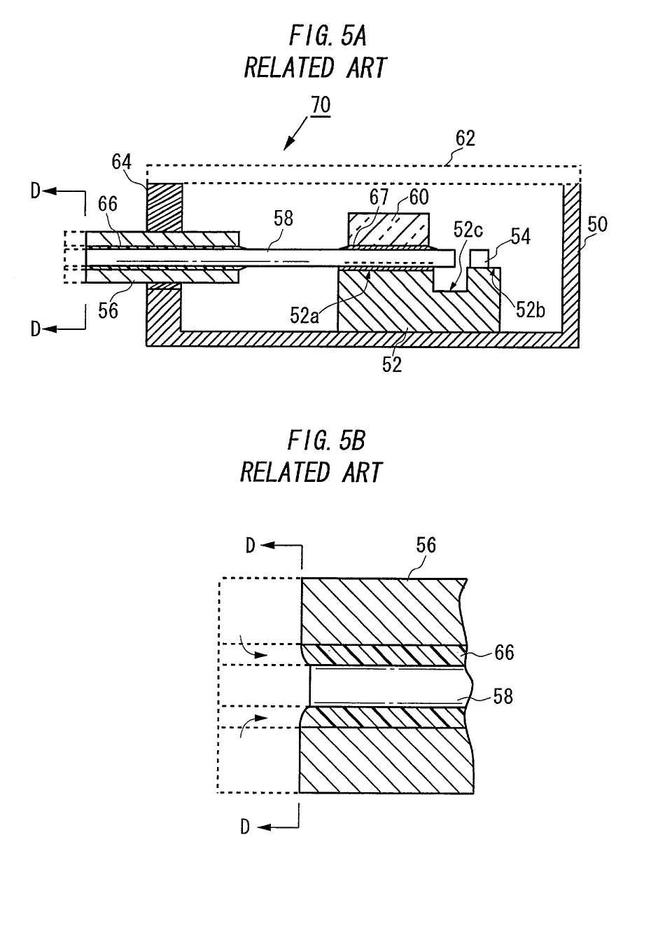

As illustrated in FIGS. 3A and 3B, the optical fiber 18 is disposed at a position such that one end surface of the optical fiber 18 precisely opposes the active layer of the LD 14. The optical fiber 18 is retained within the ferrule 16 at a notch portion of the housing 10. Within the housing 10, in a state in which a glass a plate 20 which prevents the optical fiber 18 from rising up out of the V-groove is adhered over the optical fiber 18, the optical fiber 18 is adhered in the V-groove 28 by an adhesive 27 of UV setting. The end surface of the optical fiber 18 which opposes the active layer of the LD 14 is stress-ruptured to a mirror-finished surface, while the other end surface of the optical fiber 18 is polished to a convex spherical surface.

The ferrule 16 which retains the optical fiber 18 at a notch portion of the housing 10 is structured to be substantially cylindrical. The ferrule 16 adhesively retains at the inner peripheral surface thereof the optical fiber 18 with an epoxy resin adhesive 26 which has a glass-transition temperature Tg in the range of from about 90° C. to about 130° C. such as #9390 (product name; manufactured by NTT Advance Technology Co.). The epoxy resin adhesive which has a glass-transition temperature Tg in the range of from about 90° C. to about 130° C. corresponds to a second adhesive of the present invention.

Here, #9390 is used as an adhesive 26. However, other kinds of adhesive such as #UV 1100 (product name; manufactured by Optdine Co.) or the like can be used as long as the adhesive 26 has a glass-transition temperature Tg in a range of from about 90° C. to about 130° C., and the glass-transition temperature Tg is preferably higher than that of an adhesive 24 which binds the housing 10 and the ferrule 16 as will be described below.

The outer periphery surface of the ferrule 16 is adhered to the housing 10 by an epoxy resin adhesive 24 which has a glass-transition adhesion Tg in the range of from about 65° C. to about 90° C. such as #5813 (product name; NTT Advance Technology Co.). The epoxy resin adhesive 24 which has a glass-transition adhesion Tg in the range of from about 65° C. to about 90° C. corresponds to a first adhesive of the present invention.

Here #5813 is used as the adhesive 24. However, other kinds of adhesives such as #5814 (product name; manufactured by NTT Advance Technology Co.), #5815 (product name; manufactured by NTT Advance Technology Co.) or the like can be used as long as the adhesive has a glass-transition temperature Tg in a range of from about 65° C. to about 90° C., and the glass-transition temperature Tg which is preferably lower than that of the adhesive 26 which binds the ferrule 16 and the optical fiber 18.

After lead portions 72 are placed on electrodes 82 of a distribution substrate 80 with solder balls 84 interposed between the lead portions 72 and the electrodes 82, reflow soldering is performed. That is, the planar packaged optical module 30 having such a structure is left for about thirty seconds in a high-temperature environment at 240° C. As illustrated in FIGS. 3A and 3B, the result is a planar packaged optical module in which there is no positional displacement of the optical fiber within the ferrule and which is sufficiently suitable for reflow soldering.

In this manner, the planar packaged optical module of a first embodiment of the present invention can prevent shifting of the optical fiber and the ferrule from their design positions and positional displacement of the optical fiber within the ferrule resulting from a movement of the optical fiber therein. Thereby, the output variance from the optical fiber can be suppressed.

The planar packaged receptacle optical module of the first embodiment of the present invention is a transmission module that uses the LD 14 to convert electrical signals from the outside into optical signals. However, the present invention is not limited to a transmission module. In place of the LD 41, a light-receiving module that uses a light-receiving device photodiode may also be suitably used.

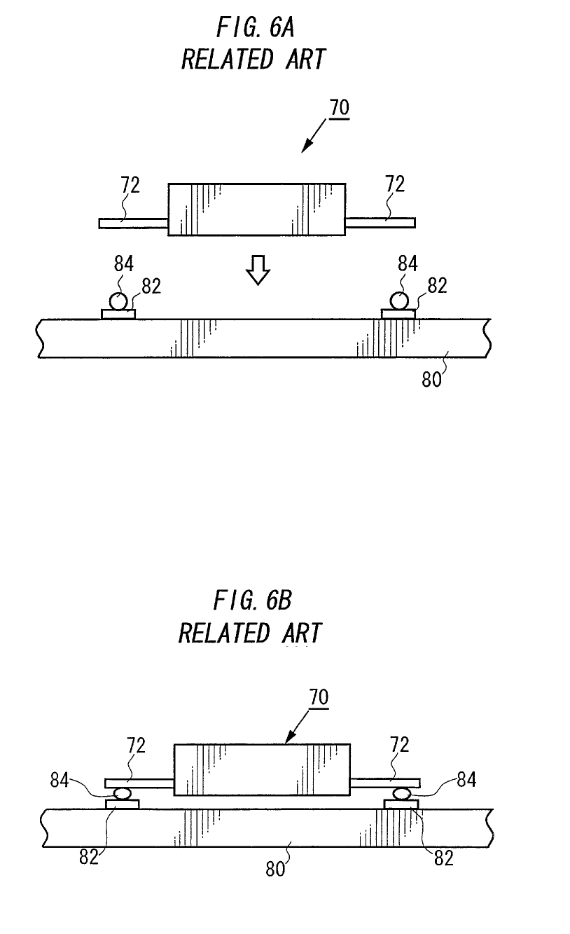

Below, a second embodiment of the present invention will be described with reference to FIGS. 6A and 6B. Since a planar packaged optical module of the second embodiment in the present invention, which is almost the same planar packaged optical module of the first embodiment, is used, a description of the planar packaged optical module is omitted. In the second embodiment of the present invention, a transmission substrate mounts the planar packaged optical module 30 of the first embodiment on a distribution substrate 80 using solder balls 84 as shown in FIGS. 6A and 6B.

An adhesive having a glass transition temperature Tg ends up exceeding a melting point of solder balls is used for an adhesive 27 of UV setting. A polyimide resin or a glass of a low melting point is desirably used for the adhesive 27 of UV setting. The adhesive having the glass transition temperature Tg of about 270° C. can be used in a case where the polyimide resin is used, and the adhesive having the glass transition temperature Tg of about 300° C. can be used in a case where the glass of the low melting point is used. The glass-transition temperature Tg of the adhesive 26, which bonds the ferrule 16 and the optical fiber 18 may not be higher that of the adhesive 24, which bonds the housing 10 and the ferrule 16. The adhesive 27 of UV setting corresponds to an adhesive as claimed in claim 4 of the present invention.

In the planar packaged optical module 30 of the structure described above, the lead portions 72 are placed on the electrodes 82 of the distribution substrate 80 with the solder balls 84 interposed between the lead portions 72 and the electrodes 82. Thereafter, reflow soldering is performed, that is, the planar packaged optical module 30 is left for about thirty seconds in a high-temperature environment at 240° C. A transmission substrate of the second embodiment is formed.

Since, in the transmission substrate of the second embodiment, the optical fiber and the Si substrate are bonded by an adhesive having a glass transition temperature higher than that of a melting point of soldering, the adhesive to bond the optical fiber and the Si substrate are never softened at a time of reflow soldering. It is possible to prevent from displacing a distance between the optical fiber and the LD at the time of reflow soldering, and thereby output variance from the optical fiber can be suppressed.

According to the present invention, since timing so that adhesive harden is displaced, displacement of the optical fiber due to movements of the optical fiber within the retaining member in an environment having a high temperature at the time of reflow soldering. The adhesives are between a housing and a retaining member, and between the retaining member and an optical fiber.

Since insertion of the optical fiber into a ferrule is wore away by reflow soldering, an effect to suppress output variance from the optical fiber can be obtained.

Since an adhesive which bonds an optical fiber and an Si substrate is never softened once in a high-temperature environment at a time of reflow soldering, it is possible to prevent from displacing a distance between the optical fiber and an LD.

Since the distance between the optical fiber and the LD is changed, the effect to suppress output variance from the optical fiber can be obtained.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is therefore contemplated that the appended claims will cover any such modifications or embodiments as fall within the true scope of the invention.

What is claimed is:

1. A planar packaged optical module comprising:
a housing;
a mounting portion provided within the housing;
a conversion device provided within the housing, the conversion device being operable for converting one of an electric signal and an optical signal substantially into the other;
a retaining member provided in the housing;
an optical fiber the optical fiber being mounted on the mounting portion such that an end surface of the optical fiber opposes the conversion device, being fixed to the retaining member, and extending from the inside to the outside of the housing; wherein
the retaining member is adhered to the housing by a first adhesive, the first adhesive being made of a first resin having an intrinsic glass-transition temperature, and the retaining member is adhered to the optical fiber by a second adhesive, the second adhesive being made of a second resin having an intrinsic glass-transition temperature greater than the glass-transition temperature of the first resin.

2. The planar packaged optical module as claimed in claim 1, wherein the first and the second resin are formed of a thermoplastic resin.

3. The planar packaged optical module as claimed in claim 1, wherein the retaining member extends from the inside to the outside of the housing.

4. A transmission substrate for mounting a planar packaged optical module on a distribution substrate by using soldering, wherein the planar packaged optical module comprises:
a housing;
a mounting portion provided within the housing;
a conversion device provided within the housing, the conversion device being operable for converting one of an electric signal and an optical signal substantially into the other;
a retaining member provided in the housing;
an optical fiber being mounted on the mounting portion such that an end surface of the optical fiber opposes the conversion device, being fixed to the retaining member, and extending from the inside to the outside of the housing, and wherein
the optical fiber is adhered to the mounting portion by an adhesive, the adhesive being made of a resin having an intrinsic glass-transition temperature greater than a melting point of soldering.

5. The transmission substrate as claimed in claim 4, wherein the resin is formed of a polyimide resin or a glass.

6. The transmission substrate as claimed in claim 4, wherein the retaining member extends from the inside to the outside of the housing.
